(19) United States
(12) Patent Application Publication
(10) Pub. No.: US 2011/0082749 A1
(43) Pub. Date: Apr. 7, 2011

(54) System And Method For Template-Based Assembly Of Publications

(75) Inventors: John Rivlin, Palo Alto, CA (US); Garth Conboy, La Jolla, CA (US); Vincent Le Chevalier, San Jose, CA (US)

(73) Assignees: FirstPaper, LLC, New York, NY (US); eBook Technologies, Inc., La Jolla, CA (US)

(21) Appl. No.: 12/574,025

(22) Filed: Oct. 6, 2009

(51) Int. Cl. G06Q 30/00; G06F 17/20

(52) U.S. Cl. 705/14.66; 715/234; 705/14.4

(57) ABSTRACT

A system, method, and computer readable medium for template-based assembly of an electronic publication are disclosed. The system may include a template provider that provides a template that specifies a markup for the electronic publication and having a plurality of content slots; a content provider that provides content; a publisher that formats the content according to the template and comprising a language processor that automatically traverses the template and applies the content to the content slots; and an electronic reading device that displays the formatted content. The method may include receiving at least one template from a template provider; traversing one of the template to identify a content slot; retrieving content for insertion into the identified content slot; applying a markup to a portion of the content; formatting the content by inserting the content into the identified content slot; and rendering the formatted content on an electronic reading device.

### BACKGROUND INFORMATION

Printed and electronic publications are often associated with their unique and distinctive layouts. For example, the New York Times has a layout that is immediately recognizable—its articles are written in long, vertical columns and it uses distinct fonts for the name of the paper and the article headlines, bylines, and text. The USA Today newspaper has a different layout—it has wide columns and uses a larger font. The layout of these, and other publications, can be thought of as their templates.

### BRIEF DESCRIPTION OF THE DRAWINGS

The present invention, together with further objects and advantages, may best be understood by reference to the following description taken in conjunction with the accompanying drawings, in several figures of which like reference numerals identify like elements, and in which:

FIG. 1 is an illustration depicting a system for template-based assembly of publications according to one embodiment;

FIG. 2 is a schematic of an electronic reading device according to one embodiment;

FIG. 3 is an illustration depicting a system for template-based assembly of publications according to one embodiment;

FIG. 4 is a flowchart depicting a method for template-based assembly of publications according to one embodiment;

FIGS. 5a-i depict example code for a template according to one embodiment;

FIGS. 6a-b depict example code for a template according to one embodiment;

FIGS. 7a-b depict example code for a template according to one embodiment;

FIG. 8 depicts a method for rendering an electronic publication according to one embodiment;

FIG. 9 depicts a screen shot of a display using one template according to one embodiment;

FIG. 10 depicts a screen shot of a display using one template according to one embodiment;

### DETAILED DESCRIPTION OF PREFERRED EMBODIMENTS

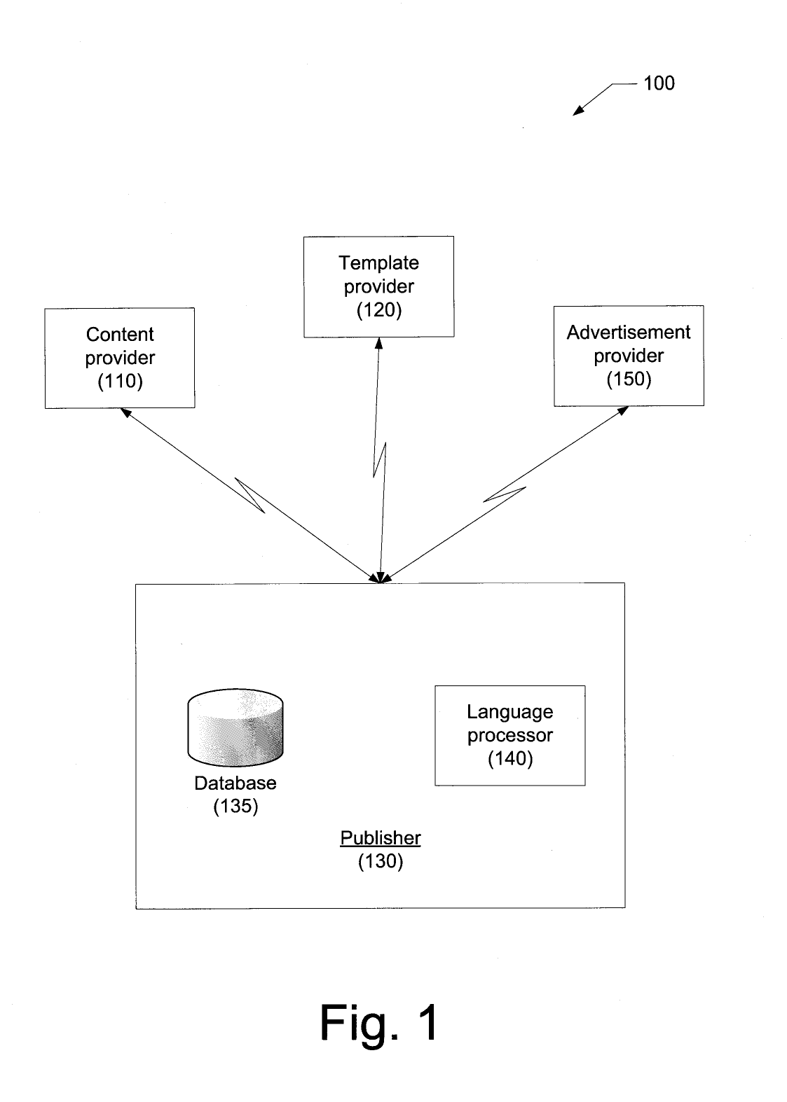

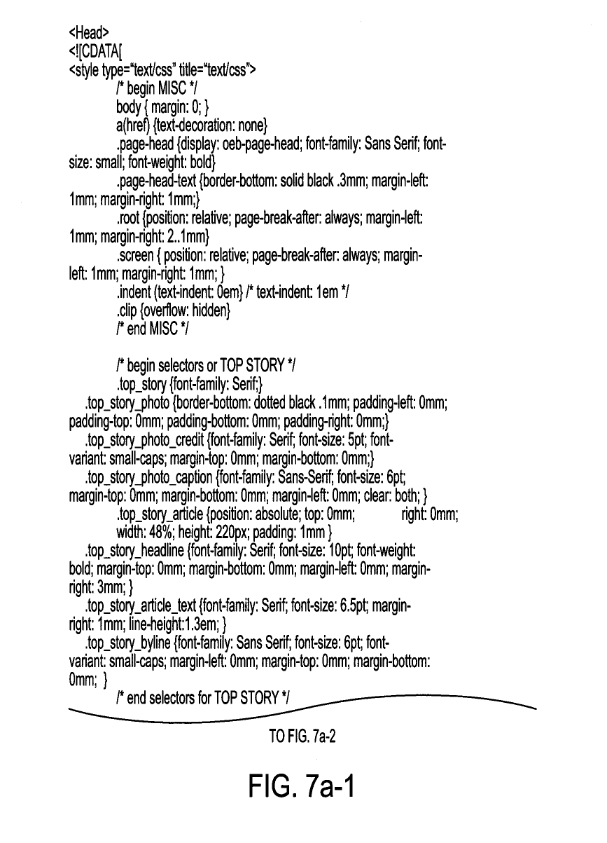

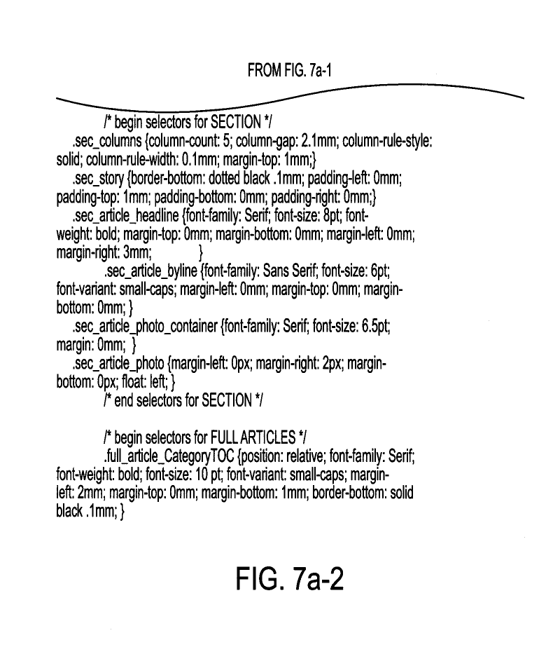

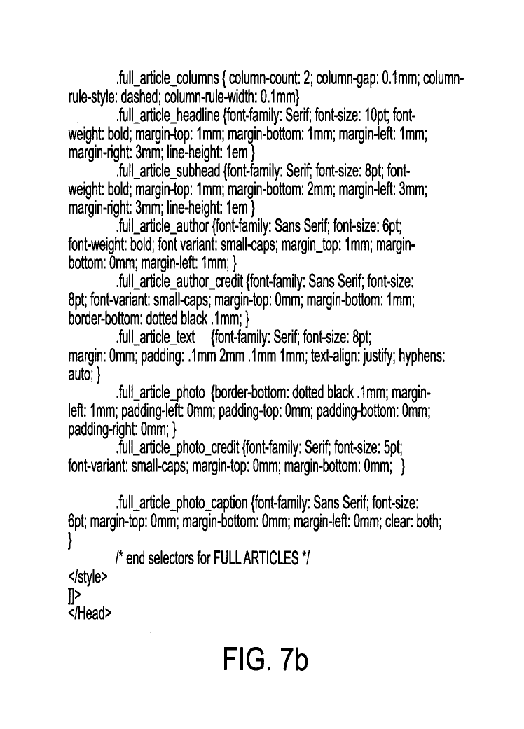

Several embodiments of the present invention and their advantages may be understood by referring to FIGS. 1-10 wherein like reference numerals refer to like elements.

Referring to FIG. 1, a system for template-based assembly of publications is disclosed. System 100 includes content provider 110, template provider 120, and publisher 130. In one embodiment, content provider 110, template provider 120, and publisher 130 may be separate entities. In another embodiment, some, or all, of content provider 110, template provider 120, and publisher 130 may be part of the same entity, or may be the same entity.

Content provider 110 provides content that may be rendered on an electronic reading device. Examples of content provider 110 include newspaper publishers, periodical publishers, book publishers, Internet authors, schools, government agencies, etc.

In one embodiment, content provider 110 may be the author of the content. In another embodiment, content provider 110 may be a distributor of content.

In one embodiment, the template may specify at least one markup to be applied to the various portions of the content.

In one embodiment, advertisement provider 150 may be provided. Advertisement provider 150 may be, for example, a business entity that provides advertisements to publisher 130. Advertisement provider 150 may also be an individual. In another embodiment, advertisement provider 150 may be an aggregator of advertisements.

Template provider 120 may provide templates that may be applied to content. In one embodiment, a template may be applied to the content as it is being rendered on an electronic reading device. In another embodiment, a template may be applied to the content before it is provided to an electronic reading device. In yet another embodiment, a template may be applied to content as or just before it is printed.

In one embodiment, content provider 110 may provide a template with its content. In another embodiment, content provider 110 may also author templates for the content provided by other content providers 110.

In one embodiment, the template may have a plurality of slots for receiving content. For example, the template may include certain areas for receiving certain content, including text, photos, etc. In one embodiment, the number, size, location, etc. of the slots may depend on the layout of the template.

In one embodiment, the template may have a plurality of advertisement slots for receiving advertisements. In one embodiment, the number of advertisement slots may vary with the cost of the template. For example, a free template may have more advertisement slots than a template that a customer purchases.

In one embodiment, the content, the advertisements, and the template may be transmitted independently from content provider 110, template provider 120 and advertisement provider 150 to a publisher 130. In one embodiment, multiple publishers 150 may be provided. Final layout and assembly may take place at a plurality of locations, including, for example, at content provider 110, at a centralized distribution server, on a client device in the field, etc.

In one embodiment, the advertisements may be streamed to publisher 130. In another embodiment, the advertisements may be targeted. For example, different advertisements may be provided for different electronic reading devices. In another embodiment, different advertisements may be provided based on location, demographics, etc. of the customer. In another embodiment, the advertisements may change as the publication is rendered. Other types of advertisements and/or techniques for displaying the advertisements may be used as necessary and/or desired.

Publisher 130 may apply the template provided by template provider 120 to the content provided by content provider 110 and the advertisements provided by advertisement provider 150. In one embodiment, publisher 130 may provide the content with the template applied to be rendered in an electronic reading device.

Publisher 130 may be able to proof and modify the look of an electronic publication without having to explicitly place each article. The content slot for each article may be programmatically determined based on the characteristics of the article. In one embodiment, characteristics of the article may include the article word count, length of the article title, length of byline, size of font, number of pictures or graphics, size of pictures or graphics, etc.

In one embodiment, the placement of articles, pictures, and advertisements may be heuristically determined.

In one embodiment, publisher 130 may include database 135 and language processor 145. Database 135 may be any suitable database. In one embodiment, database 135 may be a relational database. In another embodiment, database 135 may comprise a plurality of databases. In yet another embodiment, database 135 may be located remotely from publisher 130.

Database 135 may receive and store content and templates.

In another embodiment, advertisement provider 150 may be provided as a database to publisher 130.

In another embodiment, database 135 may be memory 210 of electronic reading device 200.

Language processor 140 may be a software application executed by a processor. In one embodiment, language processor 140 may operate on an extensible markup language (XML) dialect. In another embodiment, language processor 140 may operate on JSON. Other languages and/or syntaxes may be used as necessary and/or desired.

For example, some or all of the following elements may be part of the XML dialect:
<Select Trigger=“field” Identifier=“field”>—The data in Select nodes is assumed to be a SQL select statement. A query is made using the select statement and the rows returned are used as data to substitute in to any other nodes processed at the level of the <Select> tag or above. To request the substitution of a variable, the user specifies “@variable@”. This will cause the current value of “variable” to be searched for in all active queries and substituted in.
Trigger=“field”—The Trigger property identifies a field in the database that, when referenced, triggers the saving of the current value of the field identified by the Identifier property in a list of context identifiers that are passed to the Ad Server when an Ad request is made. This allows identifiers, such as ArticleIDs, to be collected for articles referenced from within a given template. In one embodiment, an Identifier property may be provided if a Trigger property is specified. This may be specified as: Trigger=“Text”.
Identifier=“field”—The Identifier property identifies a field in the database that may be saved whenever the field identified by the Trigger property is reference in the list of identifiers that gets passed to the Ad Server. This allows identifiers such as ArticleIDs to be collected for all articles actually referenced from within a given template. Note that a Trigger property may be provided if an Identifier property is specified. This may be specified as: Identifier=“ArticleID”.
<Execute>—Execute a SQL statement.
<ExecuteIfCreated>—Execute a SQL statement if the output book was successfully created.
<Head>—A Head node may be output to a separate stream from other tags and is placed before all the body data that is output. A Head section is only output once.
<BookID, Title, Author, Category, Encrypt>—These sub-elements may be stored as variables that can be referred to by the engine when creating books.
<Img>—The 1 mg element may provide the same options as the XHTML <img> element. In addition, a ScaleToFit=“Y” attribute may be specified. When this attribute is specified, the actual size of the graphics may be determined and the width and height attribute values may be replaced with a width and height that will preserve the aspect ratio of the inserted image within the originally-specified width and height rectangle. In one embodiment, the width and height should be specified in pixels.
<Ad Width=“x” Height=“y” other_img_properties/>—The Ad element specifies a location at which to insert an advertisement from the Ad Server. NewsManager may generate a request to the Ad Server for each Ad element encountered. Each Ad Server request may include the context in which the ad will be used. The Ad Server may return an appropriate advertisement. News Manager may retrieve the supplied advertisement graphic and store it along with the rest of the publication's information on the News Manager server.
Width=“x”—Specifies the width of the area that the advertisement will be inserted into. The value may be specified using any dimensional units (mm, px, pt, in, etc.).
Height=“y”—Specifies the height of the area that the advertisement will be inserted into. The value may be specified using any dimensional units (mm, px, pt, in, etc.).
In addition to the Width and Height properties, other properties may be specified. This allows such function as ScaleToFit to be used in conjunction with Ad elements.
<NewAdContext/>—The NewAdContext element may cause pending Ad elements to be processed by issuing requests to the Ad server for each of them. The context information passed to the Ad Server will include all article identifiers that have been accumulated since the previous NewAdContent element or the beginning of the edition, whichever is most recent. This gives publication designers a way of identifying which articles should be considered by the Ad Server when determining which Ad to provide. The context identifier list is cleared whenever a NewAdCotent element is processed.
<If>—The If element may allow one to conditionally process the contained elements. Each attribute name may be assumed to be a variable name as if it were enclosed in “@” characters. The variable may be looked up and compared to the data (with variable substitution) specified as the attribute value. If there is equality for all attributes/values specified, then the element may be processed, otherwise the element will be ignored.
It is also possible to specify the special attributes “And” and/or “Or” to change the processing from requiring all comparisons to be equal to only requiring a single comparison to be equal.
<IfOption>—The IfOption element functions in exactly the same manner as the <If> element except that the values that it queries may be preceded by “_” in the hashtable for there to be a match. This separates them from the rest of the variables and field values. This allows the user accessible options to be identified in templates.
A number of special variables can be referenced within values to provide specialized control:
_Previous—The previous row value of the specified column.
_PreviousIgnoreBlanks—The previous row value of the specified column ignoring any rows that have the specified column as blank or null.
_UniqueID—The numeric ID that is unique for each thread in the system. It is constructed by taking the Process ID and Thread ID and combining them.
_FirstRow—Comparison to the variable @_FirstRow@ will be true if the current row number specified in the retrieved data is 0.
A “!” character may be specified as the first character of an attribute value to negate the comparison. For example, CustomerID=“!3” would be true if the CustomerID field in the database was not 3.
<Include Src=“file”/>—The Include element replaces itself with the file referenced by its Src attribute.
<Set variable=“text”/>—Set the internal variable to the value specified in the text
<Unset Variables=“regular expression”/>—Deletes all variables that match the regular expression provided. This allows easy reversion to one or more values that have previously been set using the <Set> command.
<Evaluate variable 1=“variable2”/>—Sets variable1 to the value of the variable2 that is looked up.
<Filter Data=“x” Start=“x” Length=“x” ReplaceLinefeed=“x” TranslateFrom=“abc” TranslateTo=“def”/>—The Filter element allows modification of a data field prior to its output into the data stream. The processing depends on the attributes specified.
Current attribute options include:
Data=“x”—Specifies the field (x) in the database to use for text processing.
Start=“x”—Ignore the first x characters of the data supplied.
Length=“x”—Truncate the supplied data to x characters.
ReplaceLinefeed=“x”—Replace all linefeed characters with the string x.
TranslateFrom=“abc”—Search for characters matching the characters in the specified string and return the corresponding characters in the TranslateTo string.
TranslateTo=“def”—Search for characters matching the characters in the specified string and return the corresponding characters in the TranslateTo string.
In addition to all of the selected fields and the following special variables are available for reference using the @variable@ syntax in the template file:
_Date—The date that is being built for. This may be in the format “01/01/2006”
_DD—The day of the month in the form “01”
_D—The day of the month in the form “1”
_MMMM—The month in the form “January”
_MMM—The month in the form “Jan”
_MM—The month in the form “01” for January
_M—The month in the form “1” for January
_YYYY—The year in the form “2006”
_YY—The year in the form “06”
_#Date—The date we are building for in the form “01/01/2006” (Asian numbers)
_#DD—The day of the month in the form “01” (Asian numbers)
_#D—The day of the month in the form “1” (Asian numbers)
_#MMMM—The month in the form “January” (Asian numbers)
_#MMM—The month in the form “Jan” (Asian numbers)
_#MM—The month in the form “01” for January (Asian numbers)
_#M—The month in the form “1” for January (Asian numbers)
_#YYYY—The year in the form “2006” (Asian numbers)
_#YY—The year in the form “06” (Asian numbers)
_DayOfWeek—The day of the week in the form “Monday”
_Key—The key of the most recent built book
_Size v The size of the most recently built book in bytes
_ContentBase—The base directory for imported content
_OutputBase—The base directory for output
_PageSelection—The page number to use to select the desired page
_CategorySelection—The category to use to select the desired category
_ContentFeedID—The feed that this publication is being built for.

The template may be used to determine where to flow the different portions of content (an article, for example), and what XHTML to include for the various portions of that content (e.g., title, by-line, pictures, etc.). The output is an EPUB document.

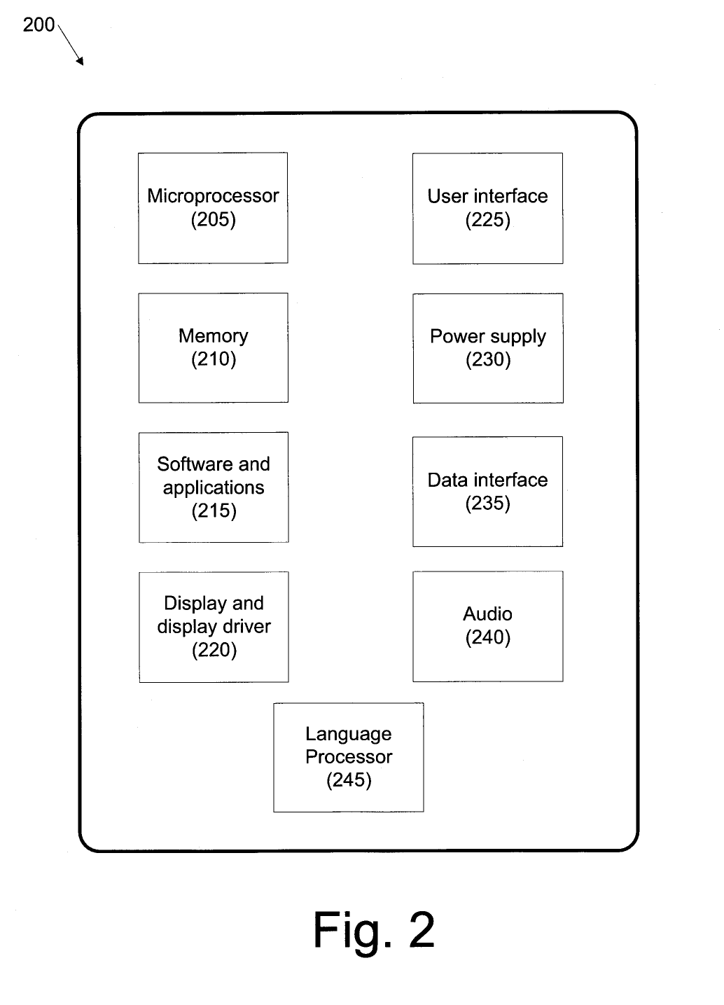

Referring to FIG. 2, a block diagram of an electronic reading device is provided. In general, electronic reading device 200 may include microprocessor 205, memory 210, software and applications 215, display and display driver 220, user interface 225, power supply 230, data interface 235, and audio 240. Other features may be provided as necessary and/or desired.

Processor 205 provides the processing power for electronic reading device 200. Processor 205 may be any suitable processor or integrated circuit, including microprocessors, programmed microprocessors, micro-controllers, peripheral integrated circuit elements, CSICs (Customer Specific Integrated Circuit) or ASICs (Application Specific Integrated Circuit), logic circuits, digital signal processors, programmable logic devices such as FPGAs, PLDs, PLAs or PALs, or any other device or arrangement of devices that is capable of performing the function of a microprocessor.

Memory 210 may be any suitable memory, and may be used to store software and applications 215. Memory 210 may be volatile or non-volatile as necessary and/or desired. Memory 210 may include static RAM, dynamic RAM, flash memory, magnetic memory, etc.

In one embodiment, memory 210 may store data files, including electronic content files, style sheets, etc. In one embodiment, software and applications 215 render an image on the display of electronic reading device 200.

Display and drivers 220 are provided for displaying characters, graphics, videos, pictures, etc. for the user. The display may be any suitable display, including flexible displays, touch-sensitive displays, etc.

User interface 225 may be provided for the user to interact with electronic reading device 200. Any suitable input mechanism may be provided. In one embodiment, buttons may be provided. In another embodiment, as discussed above, a touch-sensitive screen may be provided. In still another embodiment, a microphone may be provided to detect speech. In another embodiment, a camera may be provided. Other inputs may be provided as necessary and/or desired, depending on the application.

In one embodiment, the user may use user interface 225 to zoom on the content.

Electronic reading device 200 may be powered by power supply 230, such as a battery, AC power, DC power through an AC adapter, etc.

Electronic reading device 200 may also be provided with data interface 235. In one embodiment, data interface may be any suitable wired or wireless communication method, including cellular communications, a USB interface, unshielded twisted pair interface, radio frequency (RF), infrared (IR), Bluetooth, near field communication, WiFi (e.g., any suitable IEEE 802.11 protocol), etc.

In one embodiment, electronic reading device 200 may be provided with audio capability 240.

In one embodiment, electronic reading device 200 may include language processor 245. Language processor 245 may be similar to language processor 140, discussed above. Language processor 245 may combine the raw content data, including, for example, raw articles, images, titles, etc., with a template to render the content for the user. Language processor 245 will be described in greater detail below.

Examples of electronic reading devices include electronic book readers, electronic newspaper readers, electronic paper readers, etc. An example of an electronic display device is disclosed in U.S. patent application Ser. No. 12/481,677, entitled “Flexible Electronic Device And Method Of Manufacture,” the disclosure of which is incorporated by reference in its entirety. Other examples of electronic reading devices include the Amazon Kindle, the Sony Reader, and the Plastic Logic Reader.

Other examples of electronic reading devices include computers (desktop, notebook, laptop, tablet, etc.), personal digital assistants (PDAs), music players, telephones, etc. Any electronic reading device that is capable of rendering electronic content may be used as necessary and/or desired. For example, any electronic device having a screen or a display may be used.

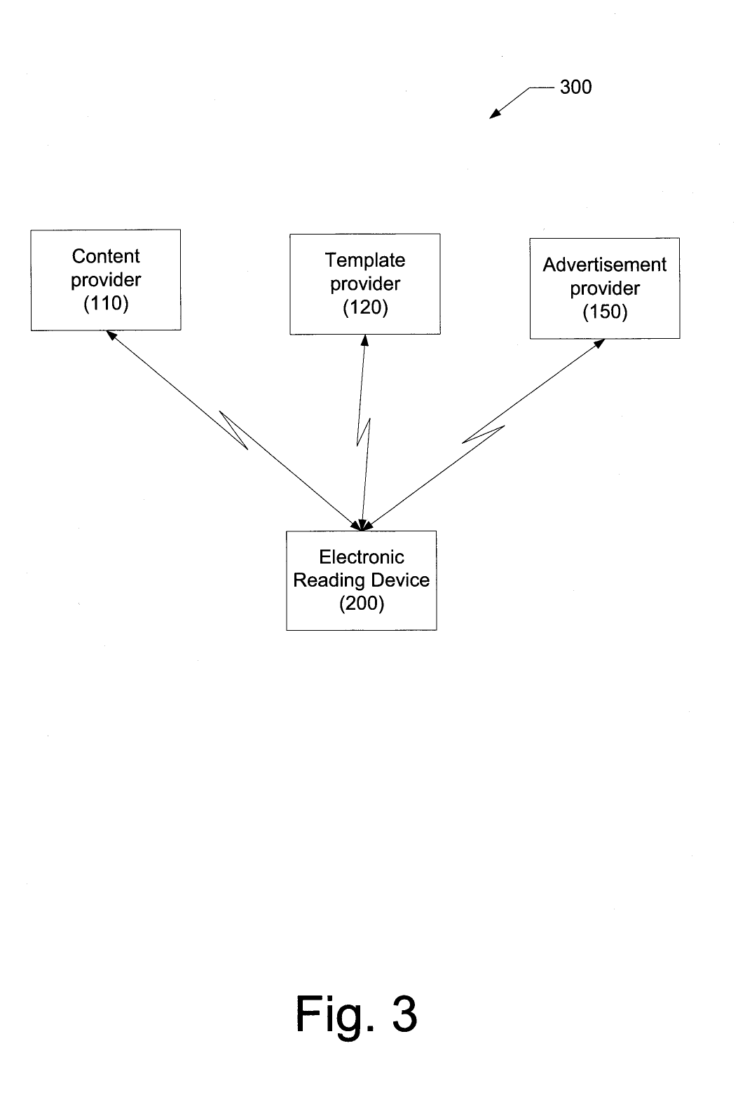

Referring to FIG. 3, a system for template-based assembly of publications is disclosed. System 300 may include content provider 110, template provider 120, and advertisement provider 150, all of which have been described above. System 300 further includes electronic reading device 200.

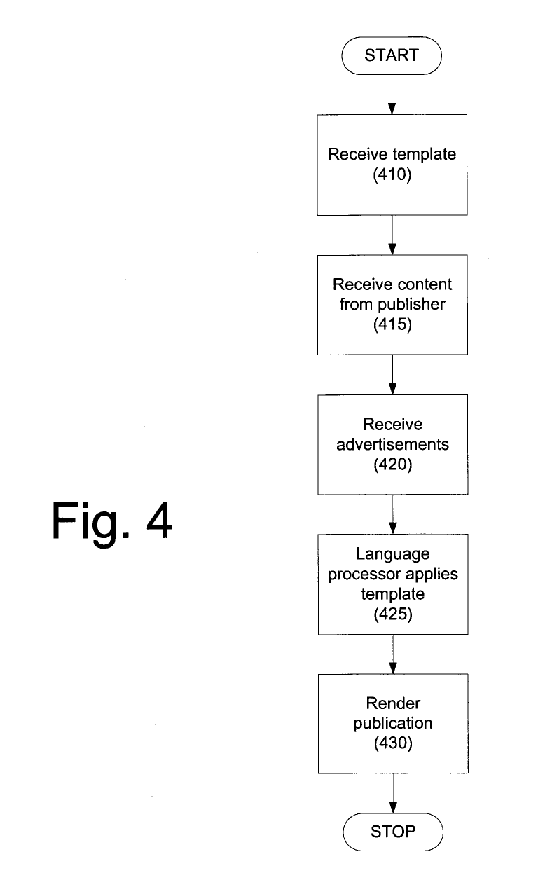

Referring to FIG. 4, a method for preparing electronic publications automatically is disclosed. In step 410, a template is received. In one embodiment, the template specifies the markup to be applied to the content. In one embodiment, the template may use the XML dialect described above.

In one embodiment, a user may also select from a plurality of templates. For example, a user may like the traditional layout of the New York Times newspaper, and is comfortable with that format. Thus, the user may apply a template for the New York Times to another publication.

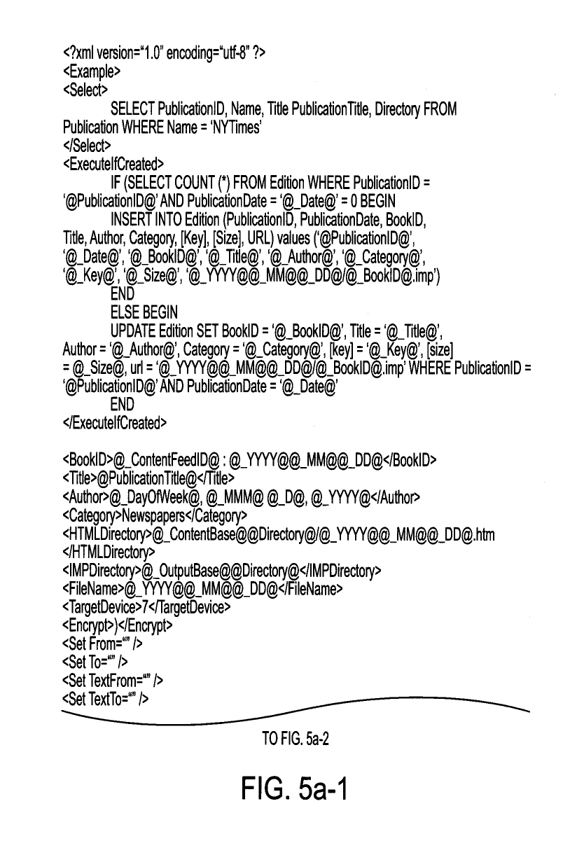

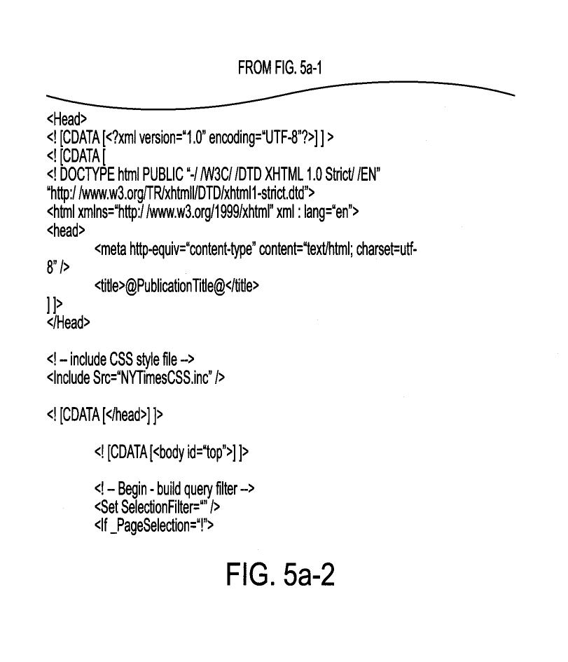

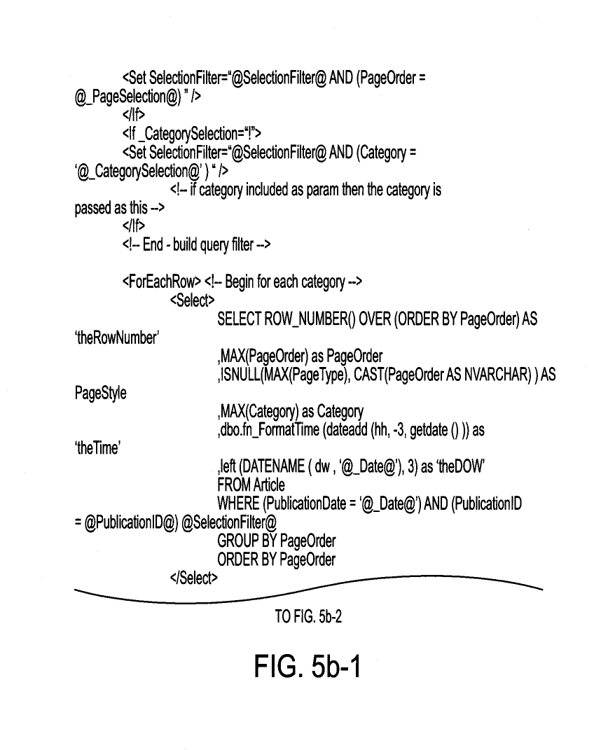

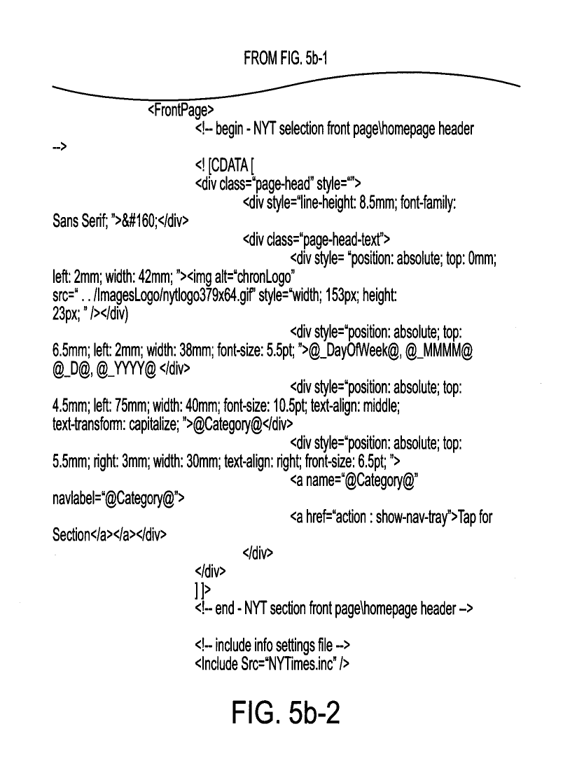

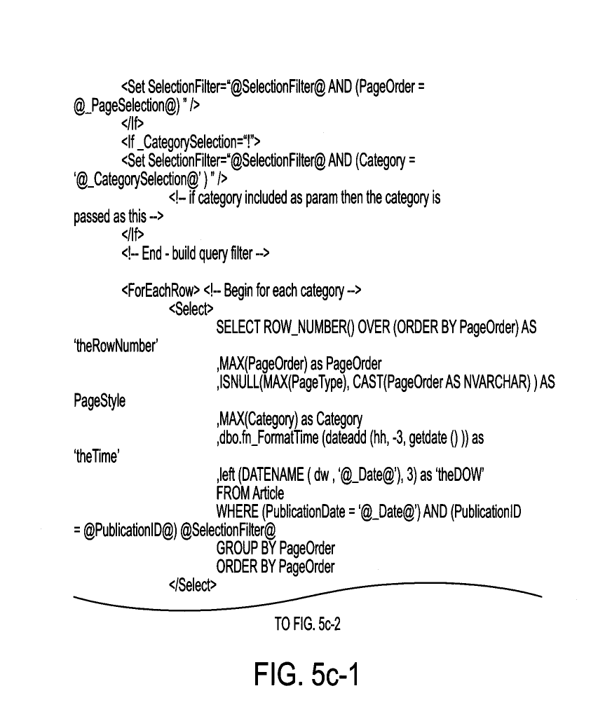

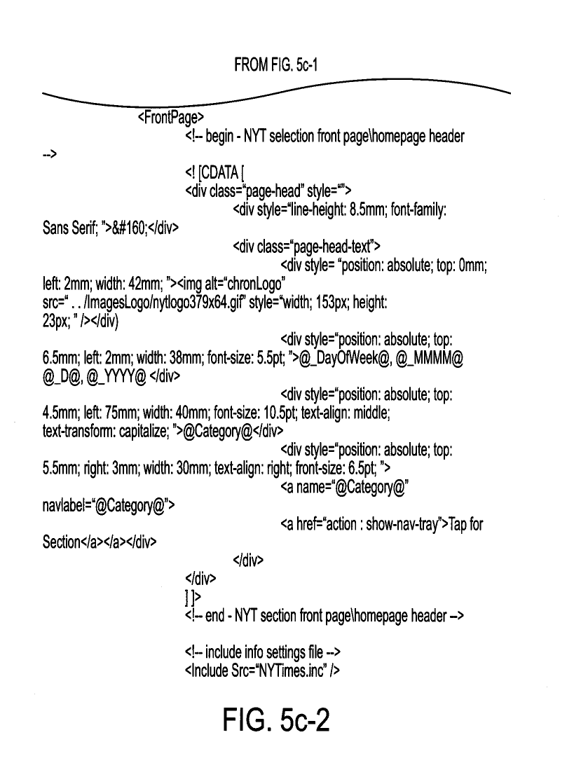

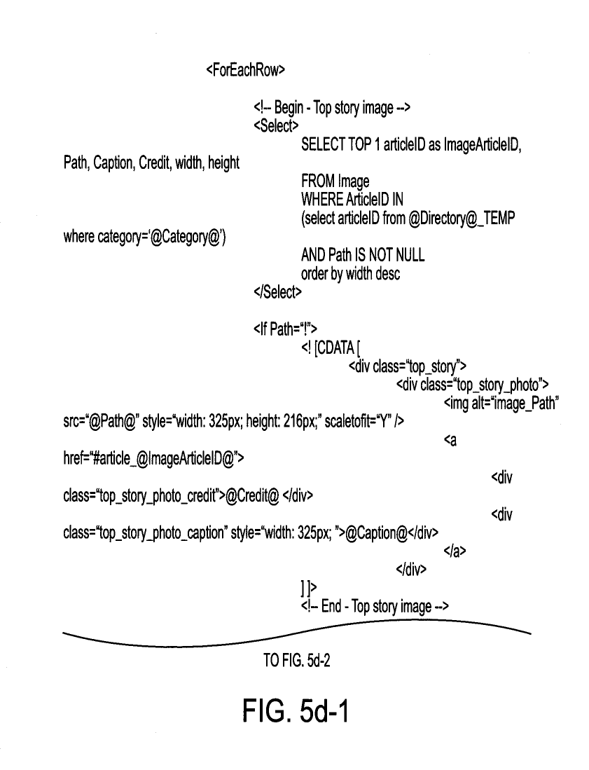

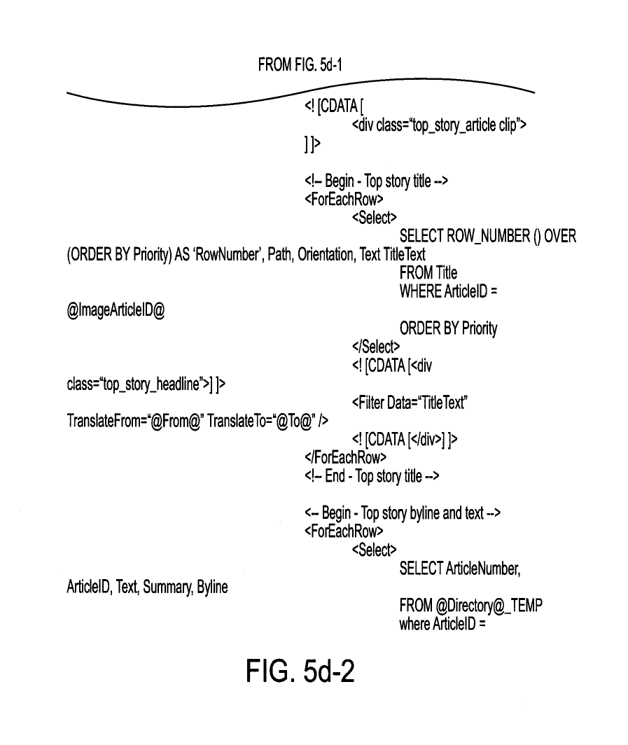

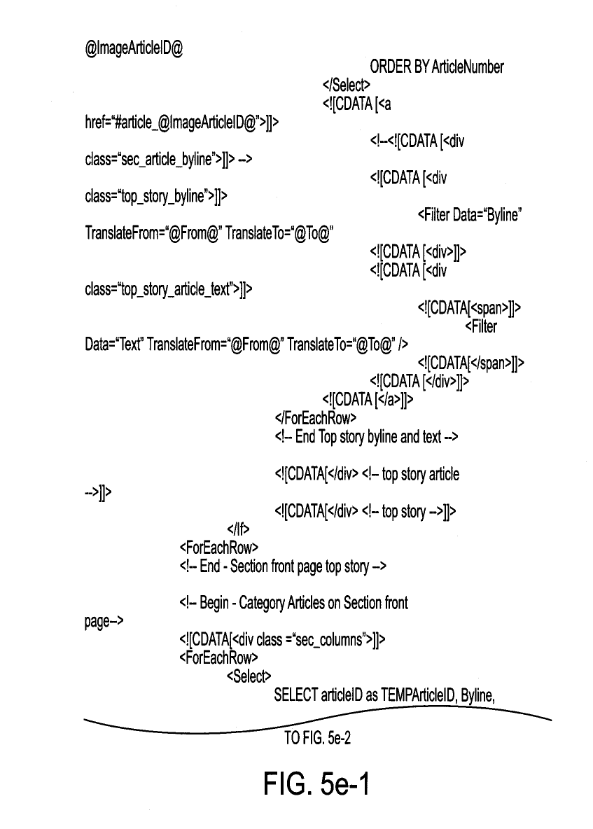

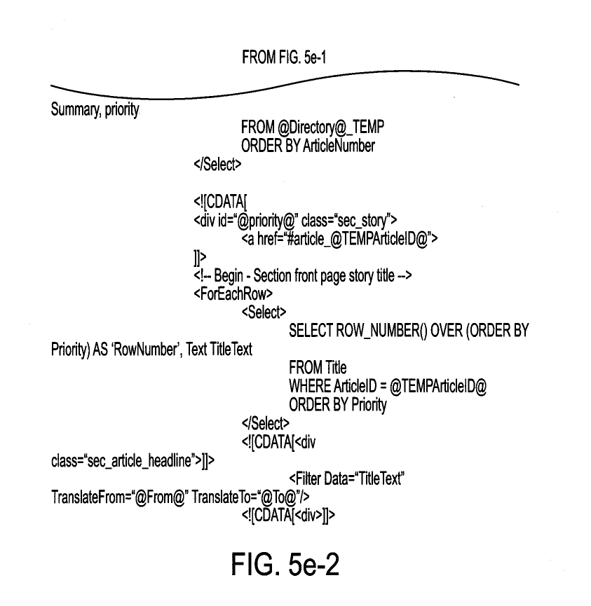

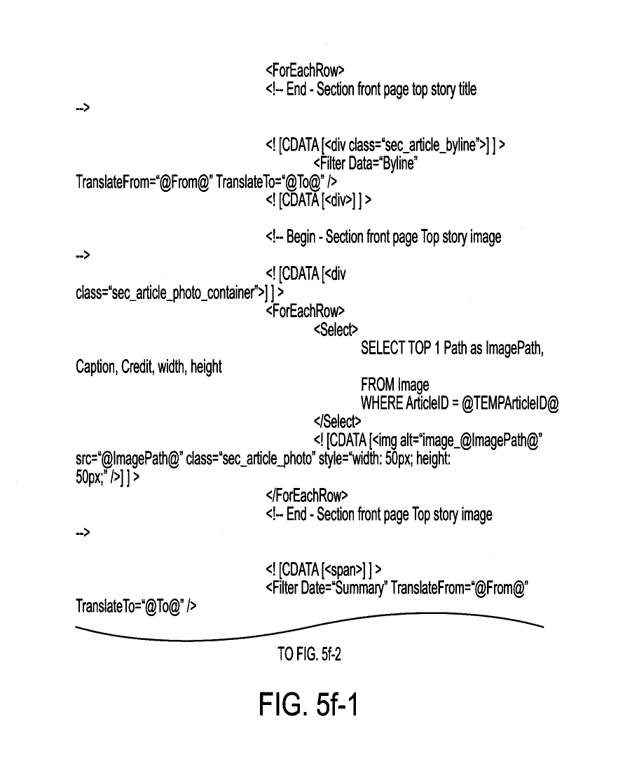

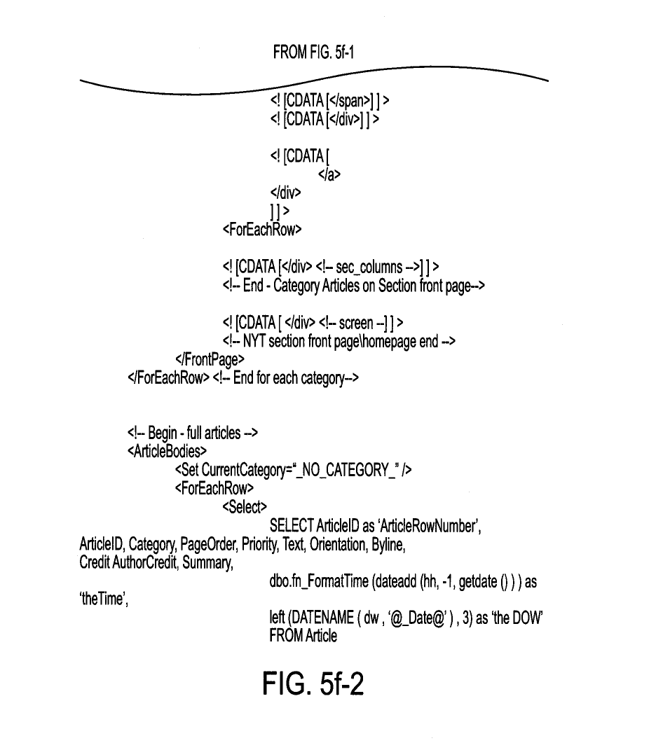

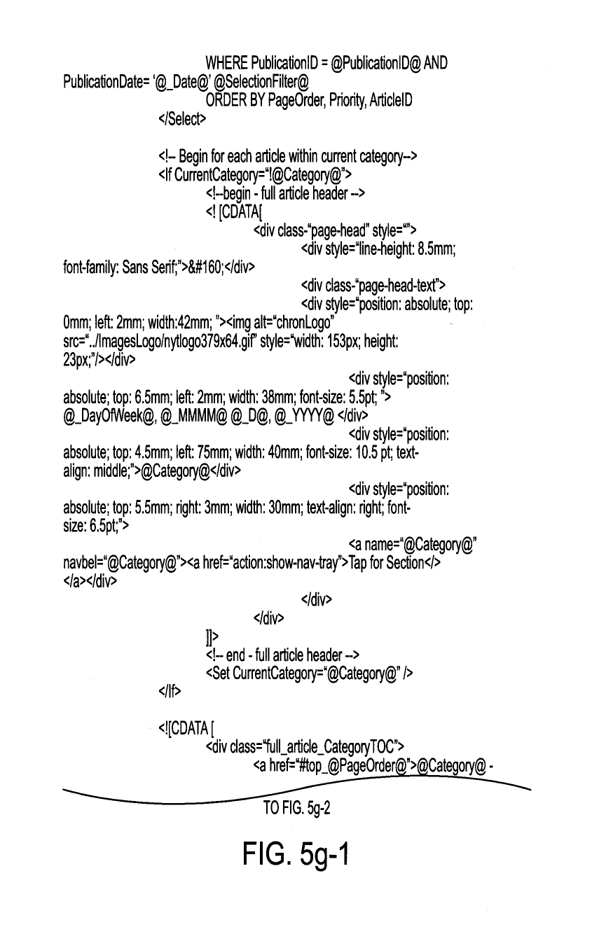

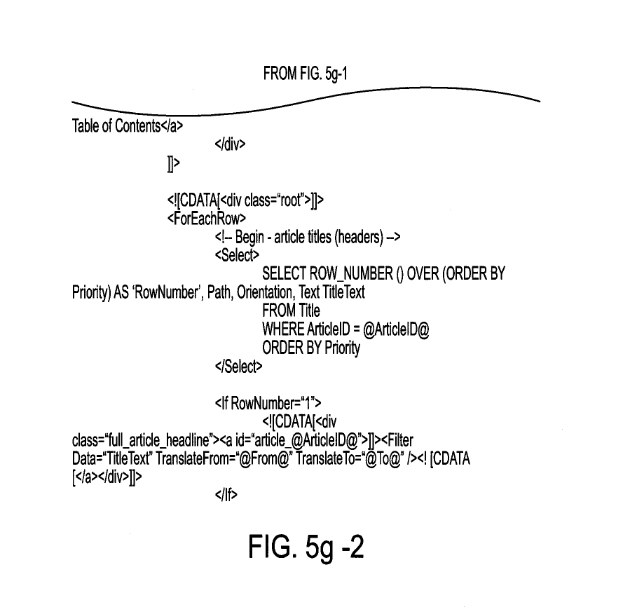

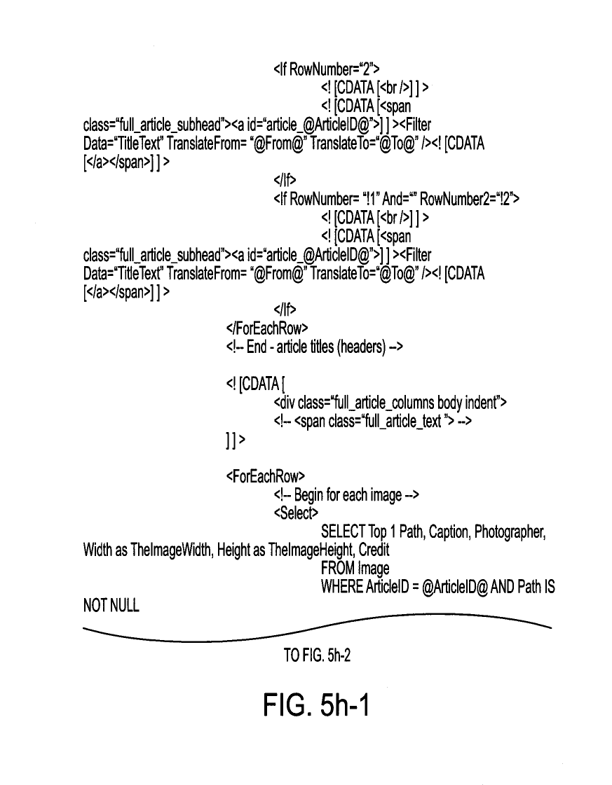

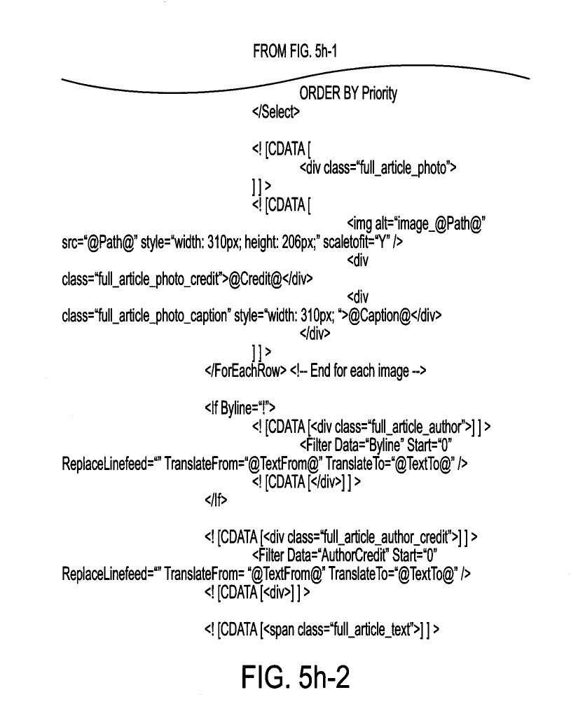

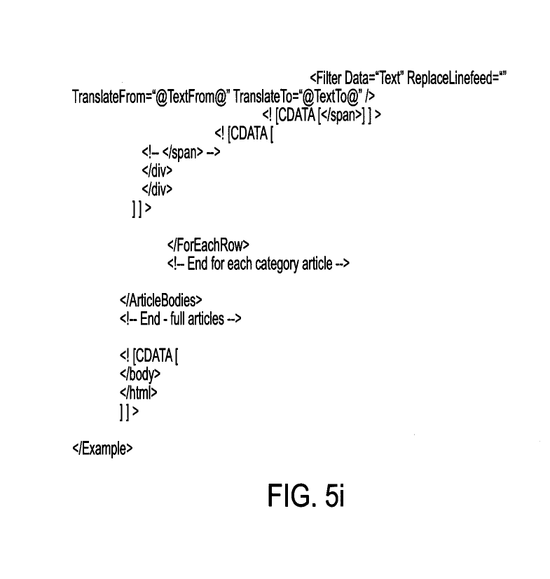

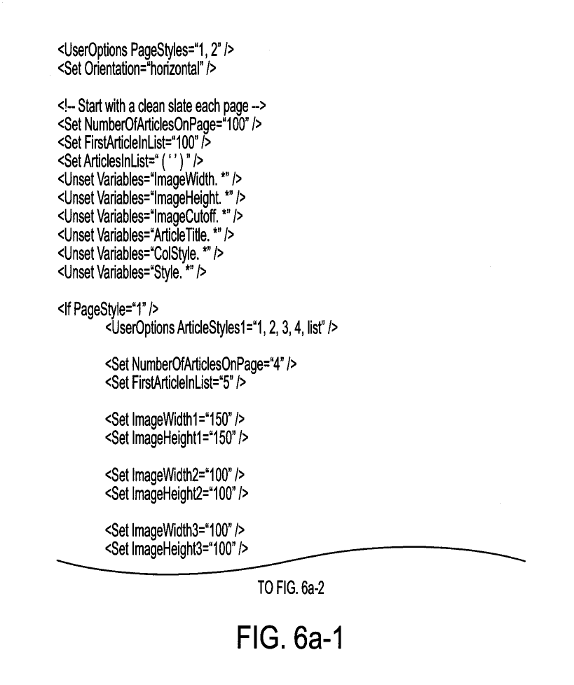

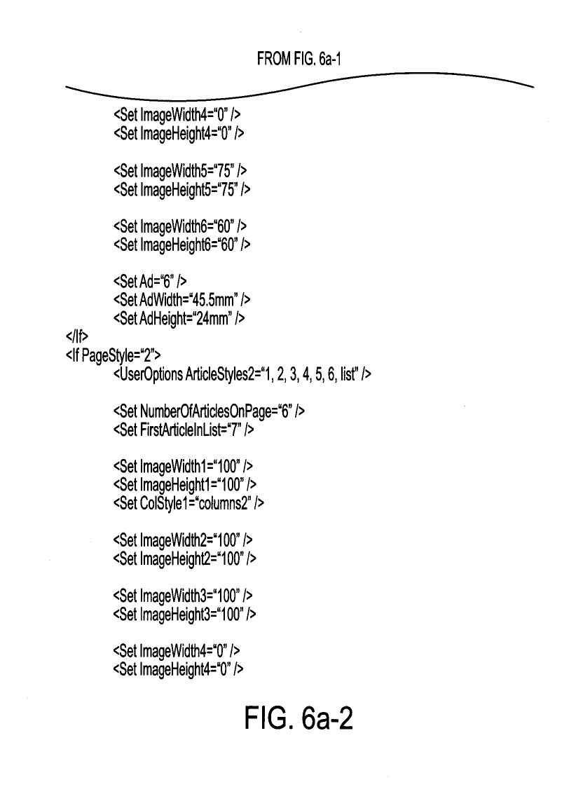

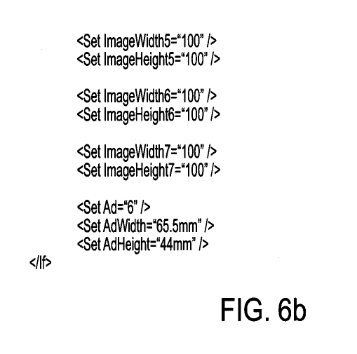

Referring to FIGS. 5a-5b, an example template similar to that of the New York Times is provided. This template refers to two files—NYTimes.inc and NYTimesCSS.inc. These include files, examples of which are provided as FIGS. 6a-b and 7a-b, respectively.

According to another embodiment, templates for other orientations, such as a horizontal layout and a vertical layout, may be provided. Templates for other newspapers, for example, the Washington Post, the LA Times, USA Today, the Wall Street Journal, etc. may be provided as necessary and/or desired.

In one embodiment, the templates may be stored in the device memory for the electronic reading device.

Referring again to FIG. 4, in step 410, content is received. Any sort of content may be provided. In one embodiment, content for an electronic publication may be provided. In another embodiment, content for an electronic book may be provided. In yet another embodiment, digital photographs may be provided. Any content that may be displayed for a user on an electronic display device may be used.

In step 420, advertisements may be provided from an advertisement provider. In another embodiment, advertisements may be retrieved from a database. In another embodiment, advertisements may be provided and assembled by the client. In another embodiment, the advertisements may be streamed. Other ways of providing the advertisements may be used as necessary and/or desired.

In step 425, the language processor applies the template to the content. In one embodiment, the language processor retrieves raw data from the database according to the markup specified in the template.

In step 430, the publication is displayed according to the template.

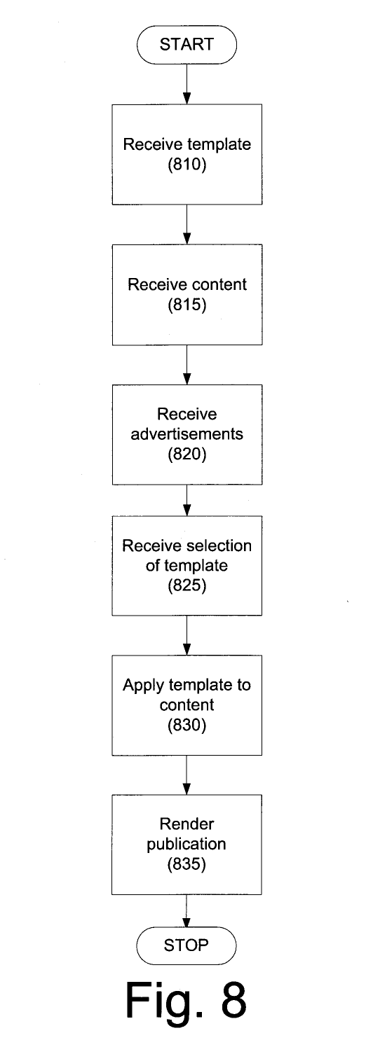

Referring to FIG. 8, a method for rendering an electronic publication according to one embodiment is provided.

In step 810, a plurality of templates are received. In one embodiment, the templates may be received from a content provider. In another embodiment, the templates may be received from a database. In still another embodiment, the templates may be received from a storage medium.

In step 815, content is received. In one embodiment, content may be received from a content provider. In another embodiment, content may be received from a database. In still another embodiment, content may be received from a storage medium.

In step 820, advertisements may be provided from an advertisement provider. In another embodiment, advertisements may be retrieved from a database. In another embodiment, advertisements may be provided and assembled by the client. In another embodiment, the advertisements may be streamed. Other ways of providing the advertisements may be used as necessary and/or desired.

In step 825, the user may select a template that it wishes to have applied to the content. In one embodiment, this may be done through any suitable input device on the electronic reading device.

In step 830, the template is applied to the content. In one embodiment, this may be performed as discussed above.

In step 835, the publication is rendered in accordance with the selected template.

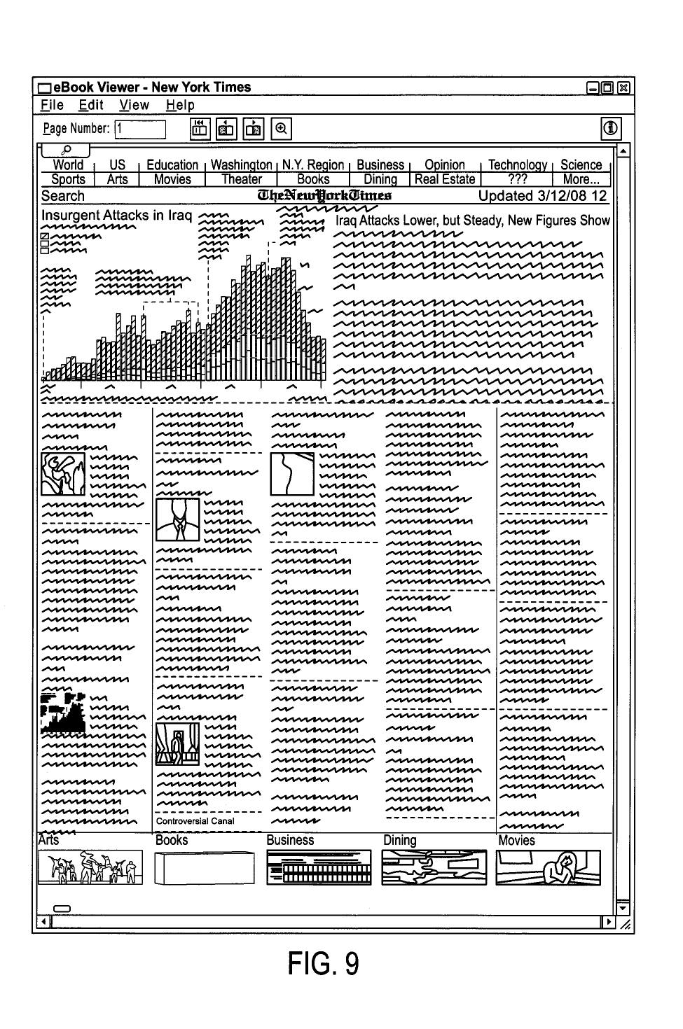

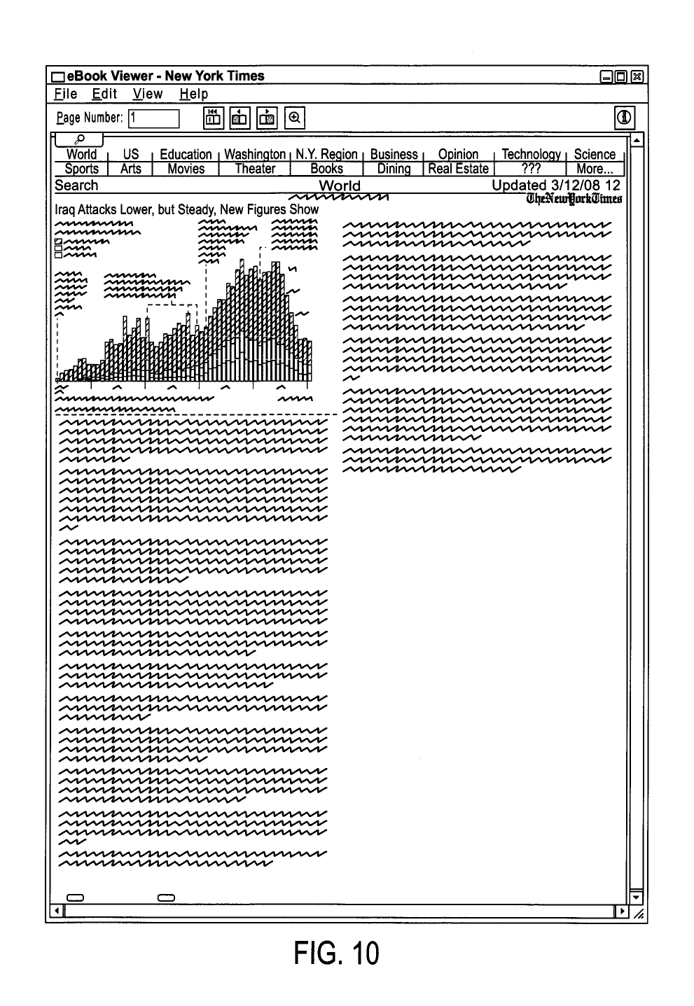

Referring to FIGS. 9-10, examples of templates applied to raw content are provided. In the example of FIG. 9, the template is a New York Times template in which a portion of an article is provided at the top, while portions of other articles are provided below. In the example of FIG. 10, an entire article is provided.

According to one embodiment, the layout method may provide resizable, resolution-independent publications. This provides a reading experience with user selectable font sizes.

According to one embodiment, the approach combines and leverages the power of database query languages, including, for example, SQL, and markup languages, for example, EPUB.

According to one embodiment, there may be cost savings realized by being able to automatically layout publications that have the appearance of hand designs.

According to one embodiment, the invention provides the ability to create attractive publications on a device using personalized information for each user while still maintaining the ability to control the layout of the information from a centralized server.

A system for template-based assembly of an electronic publication is disclosed. According to one embodiment, the system includes a template provider that provides a template, the template specifying a markup for the electronic publication and having a plurality of content slots; a content provider that provides content; a publisher that formats the content according to the template, the publisher comprising a language processor that automatically traverses the template and inserts the content into the plurality of content slots; and an electronic reading device that displays the formatted content.

A method for template-based automatic assembly of an electronic publication is disclosed. According to one embodiment, the method includes (1) receiving at least one template from a template provider; (2) traversing one of the at least one templates to identify a content slot; (3) retrieving content for insertion into the identified content slot; (4) applying a markup to at least one portion of the content; (5) formatting the content by inserting at least a portion into the content into the identified content slot; and (6) rendering the formatted content on an electronic reading device.

A computer readable medium is disclosed. According to one embodiment, the computer readable medium comprises instructions to perform the steps of: receive content for an electronic publication; receive a plurality of templates, each template specifying a markup for the electronic publication and having a plurality of content slots; receive a desired template selection from a user; and render the content according to the selected template.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, light pen, keyboard, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system for template-based assembly of an electronic publication, comprising:
a template provider that provides a template, the template specifying a markup for the electronic publication and having a plurality of content slots;
a content provider that provides content;
a publisher that formats the content according to the template, the publisher comprising a language processor that automatically traverses the template and applies the content to the at plurality of content slots; and
an electronic reading device that displays the formatted content.

2. The system of claim 1, further comprising:
an advertisement provider that provides at least one advertisement;
wherein the template further comprises advertisement slots, and the language processor applies the advertisements to the advertisement slots of the template.

3. The system of claim 1, wherein the language processor uses an XML dialect.

4. The system of claim 1, wherein the publisher is part of the electronic device.

5. The system of claim 1, wherein the content provider and the template provider are the same entity.

6. The system of claim 1, wherein the content comprises at least one newspaper article.

7. The system of claim 2, wherein the at least one advertisement is streamed to the publisher.

8. A method for template-based automatic assembly of an electronic publication, comprising:
receiving at least one template from a template provider;
traversing one of the at least one templates to identify a content slot;
retrieving content for insertion into the identified content slot;
applying a markup to at least one portion of the content;
formatting the content by inserting at least a portion of the content into the identified content slot; and
rendering the formatted content on an electronic reading device.

9. The method of claim 8, further comprising:
traversing the template to identify an advertisement slot;
receiving an advertisement for insertion into the identified advertisement slot; and
wherein the step of formatting the content by inserting at least a portion of the content into the identified content slot further comprises:
inserting the advertisement into the identified advertisement slot.

11. The method of claim 8, wherein a plurality of templates are received, and the method further comprises:
receiving a selection of a desired template of the plurality of templates from a user.

12. The method of claim 8, wherein the content comprises at least one newspaper article.

13. The method of claim 9, wherein the advertisement is streamed.

14. The method of claim 9, wherein the advertisement is targeted to a characteristic of a user.

15. The method of claim 9, wherein the advertisement comprises a plurality of advertisements, and the advertisements change as the formatted content is rendered.

16. A computer readable medium comprising instructions to perform the steps of:
receive content for an electronic publication;
receive a plurality of templates, each template specifying a markup for the electronic publication and having a plurality of content slots;
receive a desired template selection from a user; and
render the content according to the selected template.

17. The computer readable medium of claim 16, wherein the step of render the content according to the selected template comprises:
traversing the desired template to identify the content slots;
retrieving content for insertion into the identified content slots; and
formatting the content by inserting at least a portion of the content into the identified content slot;

18. The computer readable medium of claim 17, wherein the step of render the content according to the selected template comprises:
traversing the desired template to identify an advertisement slot;
receiving an advertisement for insertion into the identified advertisement slot; and
inserting the advertisement into the identified advertisement slot.

19. The computer readable medium of claim 16, wherein the content is a newspaper article.
